(19) United States
(12) Patent Application Publication
(10) Pub. No.: US 2010/0274414 A1
(43) Pub. Date: Oct. 28, 2010

(54) NARROW SPACE SLOW MOVING OPERATIONAL DEVICE FOR VEHICLE AND OPERATION METHOD THEREOF

(76) Inventor: Bonglae Park, Seoul (KR)

Correspondence Address: Edwards Angell Palmer & Dodge LLP, P.O. Box 55874, Boston, MA, 02205, US

(21) Appl. No.: 12/746,917

(22) PCT Filed: Dec. 9, 2008
(86) PCT No.: PCT/KR08/07262

§ 371 Date: Jun. 8, 2010

(30) Foreign Application Priority Data
Dec. 9, 2007 (KR) 10-2007-0127263
Dec. 10, 2007 (KR) 10-2007-0127912
Feb. 18, 2008 (KR) 10-2008-0014242
Dec. 8, 2008 (KR) 10-2008-0124029

(51) Int. Cl. B60W 30/06; B60W 10/06; B60W 10/10; B60W 10/18; B60W 10/20; B60W 10/30

(52) U.S. Cl. 701/2

(57) ABSTRACT

The present invention completely removes inconvenience when big body size drivers and passengers, who can get in/out of a vehicle only through a wide space as compared with normal body size people, or drivers sitting in wheelchairs, get in/out of a vehicle, by allowing a driver to move his/her vehicle V which all of the passengers, including the drivers, have got out of, using a remote controller 1, when the space where the vehicle V is positioned is not sufficient such that the driver can open the doors by first and second vehicles A, B around.

### TECHNICAL FIELD

The present invention relates to slow movement of a vehicle, particularly a narrow space slow moving operation apparatus for vehicle and operation method thereof.

### BACKGROUND ART

In general, vehicles are necessary for present-day life and equipped with various devices for improving function and convenience to provide convenience in addition to safety.

As an example of these devices for convenience, devices to help park a vehicle are widely used, in which a vehicle is commonly equipped with an ultrasonic sensor that detects a distance between an object and a vehicle and an ECU that receives a sensor signal to ensure a safe space for the vehicle that is moving forward or backward for parking helps the driver safely park, using an internally stored logic program.

In addition, in order to help handicapped people who have difficulty in getting in/out of a vehicle, particularly drivers or passengers using a wheelchair, to conveniently get in/out of a vehicle, a variety of assistant devices, such as power devices that moves up/down wheelchairs so they can get in/out of the vehicle while sitting on the wheelchairs, are selectively equipped, if necessary, so that they can conveniently use the vehicle.

As described above, various devices for convenience are applied to vehicles to provide convenience in using the vehicles; however, there are some cases that, even if theses devices are provided, it is significantly uncomfortable to use a vehicle in a practical situation or it is impossible to use the vehicle for a short while.

For example, when the space between vehicles is insufficient to open the door after being parked or the space around has decreased, in unparking, it is practically impossible to get in/out of the vehicle without moving the vehicles around.

In particular, when people with big bodies, pregnant women in full term, or people sitting in wheelchairs have to get in/out of a vehicle, they feel the above inconvenience that is caused when the space around their vehicles is not enough to open the door. Further, they may not be able to unpark their vehicles if they cannot contact the drivers of the vehicles around.

### DISCLOSURE OF INVENTION

### Technical Problem

Accordingly, the present invention was designed in consideration of the above problems, and it is an object of the present invention to makes it possible for a driver to drive his/her vehicle into or out of a narrow space between other vehicles, for parking or unparking, outside the vehicle, by allowing the driver to move the vehicle without anybody inside the vehicle, including the driver, for parking or unparking, when driving a short distance, such as in a parking lot.

Further, it is another object of the present invention to relieve inconvenience for big body size drivers and passengers who cannot get in/out of a vehicle, as compared with normal body size people, because the space between vehicles is narrow, by making it possible for the driver to move his/her vehicle without getting into the vehicle, when not driving on a road, such as a parking lot.

### Technical Solution

In order to achieve the above objects, a narrow space slow moving operation apparatus for vehicle according to the present invention includes:

a remote controller that transmits various control signals to a vehicle, which all of passengers, including a driver, get out of or in which nobody is, when the vehicle is parked or needs to be parked at a narrow space between vehicles;

an unmanned slow movement shift stage LD that is added to a shift stage of a transmission to allow an ECU 2 to control the vehicle in a slow movement control mode when signals from the remote controller is received;

the ECU that controls the vehicle in response to each signal transmitted from the remote controller, with a shift lever positioned at the unmanned slow movement shift stage LD; and

a slow-moving part that moves the vehicle at a low velocity by transmitting power to wheels in response to a control signal generated by the ECU.

Further, the unmanned slow movement shift stage LD induces the parking state when the shift lever is positioned at the unmanned slow movement shift stage LD, and the slow-moving part releases the parking state in response to a control signal generated by the ECU.

For this, the slow-moving part drives an engine E in response to a control signal generated by the ECU and transmits power to the wheels.

On the other hand, the slow-moving part includes an independent power assembly that is driven by a control signal generated by the ECU and transmits power to the wheels.

Further, the independent power assembly is driven by electric power of a battery specifically provided, or power generated by the engine, and the independent power assembly rotates an impelling shaft that transmits rotation power to rear wheels.

Further, the slow-moving part moves the vehicle at a low velocity by controlling a brake pedal or/and an acceleration pedal.

On the other hand, the slow-moving part uses a low-velocity first stage of a transmission as the unmanned slow movement shift stage LD, and for this, the ECU is provided with a logic that adjusts the amount of pressing the acceleration pedal or the brake pedal to keep a slow-moving velocity, in order to minutely adjust the amount of pressing the acceleration pedal.

The slow-moving part having the above configuration release a parking lever when the parking lever is set, or generates an alarm when the shift lever SL is positioned at the unmanned slow movement shift stage LD and, at the same time, the parking lever is set.

Further, the slow-moving part moves the shift lever to the unmanned slow movement shift stage LD, when the shift lever SL is not positioned at the unmanned slow movement shift stage LD.

Further, the slow-moving part detects state of the wheels not-aligned and aligns the wheels or generates an alarm when the shift lever is moved to the unmanned slow movement shift stage LD.

Further, the slow-moving part further includes a slope detecting sensor that detects the slope condition of a road where the vehicle is positioned, and

the ECU operates in response to a control signal of the remote controller only within a predetermined slope condition range, or generates an alarm or restricts the shift lever if the predetermined slope condition range is exceeded, when the shift lever is moved to the unmanned slow movement shift stage LD.

Further, the ECU further includes a safety checking part that prevents the vehicle, which is moving, from exceeding a predetermined velocity and contacting with objects around, and

the ECU stops the vehicle, ignoring the slow movement mode of the vehicle, when receiving a signal of the safety checking part.

Further, the slow-moving part includes:

an engine start circuit that generates an engine start signal of the ECU for a vehicle;

a brake operating unit 4 that has a solenoid and a press lever for pressing and releasing the brake pedal by control of the ECU;

a wheel aligning unit that has a wheel sensor transmitting a signal about state of the wheels not-aligned to the ECU and a motion link rotating a steering wheel by a motor 8a generating power by the ECU;

an parking releasing unit that has a solenoid and a press lever 6b pulling a parking button to unlock the parking lever by control of the ECU and a motion link moving up/down the parking lever using power generated by a motor;

a shift unit that has a solenoid and press lever automatically pulling a shift button such that the shift lever is unlocked to move the shift lever to the unmanned movement shift stage LD for slow movement, and a motion link moving forward/backward the shift lever using power generated by a motor; and

an acceleration unit that has a solenoid and a press lever for pressing or releasing the acceleration pedal by control of the ECU.

Further, the independent power assembly includes an actuator generating power by control of the ECU receiving a signal of the remote controller, a decelerator increasing torque generated by the actuator, and a rotary gear generating rotational force by the decelerator to rotate the impelling shaft.

In order to achieve the above objects of the present invention, a narrow space slow moving operation method for vehicle, includes:

a step of checking a slow movement mode in which an ECU recognizing a slow movement order signal from a remote controller checks that a shift lever is positioned at an unmanned slow movement shift stage LD, or moves the shift lever to the unmanned slow movement shift stage LD;

a step of starting engine in which after the position of the shift lever at the unmanned slow movement shift stage LD is checked, the ECU presses down a brake pedal and then starts an engine;

a step of setting slow movement shift in which after the engine starts, the ECU shifts the gear from a parking state to slow movement, in response to signals of forward and backward buttons of the remote controller;

a step of moving in which after the gear is shifted, an acceleration is pressed to move a vehicle, or the brake pedal is released; and

a step of completing movement in which when a signal of a stop button 1e of the remote controller 1 is received or a predetermined distance passes, the ECU stops the vehicle by pressing down the brake pedal to stop the vehicle, shifts the gear to the parking state, and stops the engine.

On the other hand, a narrow space slow moving operation method for vehicle, includes: a step of checking a slow movement mode in which an ECU recognizing a slow movement order signal from a remote controller checks that a shift lever is positioned at an unmanned slow movement shift stage LD, or moves the shift lever to the unmanned slow movement shift stage LD 11;

a step of preparing for slow movement in which after the position of the shift lever at the unmanned slow movement shift stage LD is checked, the ECU releases parking state;

a step of independent-power movement in which after the parking state is released, the ECU operates an independent power assembly to generate output torque through an actuator and a decelerator, and rotate a rotary gear fixed to an impelling shaft using the output torque generated by the decelerator such that the impelling shaft rotates and the rear wheels are driven through a differential gear, and as a result a vehicle V is moved; and

a step of finishing movement in which when a signal of a stop button of the remote controller is received or a predetermined distance passes, the ECU stops the operation of the independent power assembly and induces parking state.

Further, in order to achieve the objects of the present invention, the narrow space slow moving operation method for vehicle further includes a step of safe movement in which, while the vehicle moves, the ECU controls the movement velocity, continuously checks whether to contact with objects around, and halts the vehicle when an abnormal situation appears, such as excess in velocity or contact with an object.

Further, in order to achieve the objects of the present invention, the narrow space slow moving operation method for vehicle further includes a step of checking safety in which when a signal is received from the remote controller, the ECU detects the slope condition of a road where the vehicle is stopped, and controls the vehicle only within a predetermined slope condition range, or when the shift lever is moved to the unmanned slow movement shift stage LD, generates an alarm or restricts the shift lever, if the predetermined slope condition range is exceeded.

### Advantageous Effects

According to the present invention, a driver can park or unpark his/her vehicle outside the vehicle, such that it is possible to remove inconvenience for the drivers and passengers getting in/out of the vehicle when driving in/out of a narrow space where the doors of the vehicle cannot sufficiently opened, and also easily move his/her vehicle without moving other vehicles around.

Further, according to the present invention, when the space between the vehicles is narrow such that drivers and passengers with big bodies or sitting in wheelchairs cannot easily get in/out of the vehicle, it is possible to move the vehicle outside the vehicle and easily get in/out of the vehicle.

Further, the present invention allows a driver, when the space where the vehicle enters is so narrow that the vehicle cannot be aligned with the space to be moved and parked into the space, to directly drive the vehicle into the narrow space, aligns the wheels of the vehicle in straight lines, drives out the vehicle with passengers, including the driver, using unmanned slow-moving operation, and then park the vehicle again in the narrow space, with nobody in the vehicle, using unmanned slow-moving operation.

### BRIEF DESCRIPTION OF DRAWINGS

FIG. 1 is a view illustrating the configuration of a narrow space slow moving operation apparatus for a vehicle according to the present invention.

FIGS. 2A to 2C, 3A, and 3B are views illustrating the configuration of components constituting the present invention.

FIGS. 4 and 5 are flowcharts of a method of achieving narrow space slow moving operation for a vehicle according to the present invention.

FIGS. 6A to 6D are views illustrating the operations for parking and unparking according to the present invention.

### BEST MODE FOR CARRYING OUT THE INVENTION

An embodiment of the present invention is described hereafter with reference to the accompanying drawings, which is an example and can be changed and modified by those skilled in the art, that is, without departing from the claims of the present invention, and the present invention is not limited to the embodiment described herein.

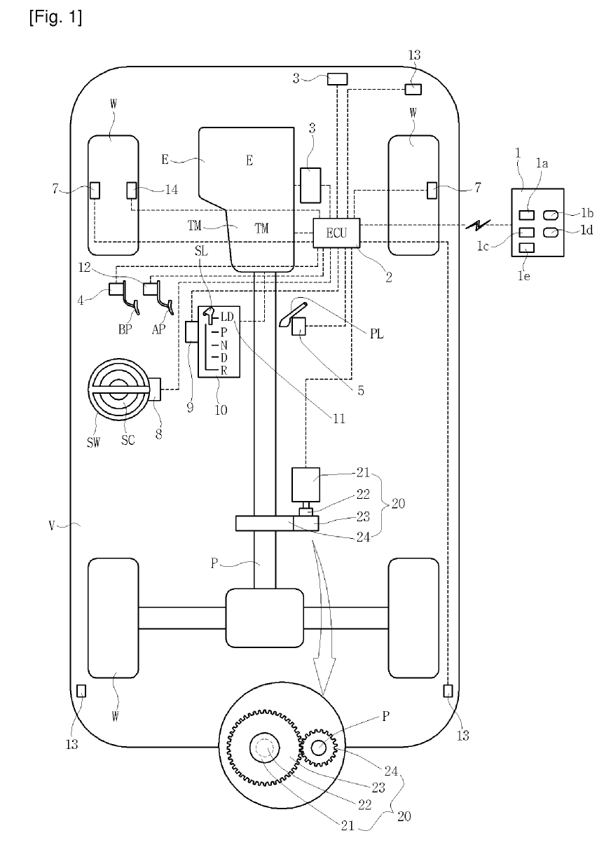

FIG. 1 is a view illustrating the configuration of a narrow space slow moving operation apparatus for vehicle according to the present invention. The narrow space slow moving operation apparatus for a vehicle according to the present invention makes it possible for a user to move, that is, park or unpark a vehicle in a narrow space between other vehicles at a low velocity of about 2 km/h or less only by simply operating a remote controller 1, with no one in the vehicle, including a driver, when it needs to move a short distance, such as in a parking lot, without influencing the driving performance of the vehicle, such that it can completely remove inconvenience that drivers or passengers with big bodies or sitting in wheelchairs feel when getting in/out of the vehicle.

The slow-moving velocity of the vehicle is a velocity that does not make drivers or other people around feel uncomfortable, and is not limited to the above-mentioned 2 km/h.

To achieve this, the narrow space slow moving operation apparatus for a vehicle is provided with a remote controller 1 that makes it possible to control a vehicle V by sending a radio signal to the vehicle V of which the engine is off.

The remote controller 1 may be achieved by adding functions, which is required for the present invention, to a common wireless engine start remote controller that is widely used, or by manufacturing a specific remote controller that is provided with functions required for the present invention.

The remote controller 1 is provided with various functions of the present invention, and for example, is provided with an engine start button 1a that provides an On-signal for starting an engine E of the vehicle V that is in stop, forward and backward buttons 1c, 1d for moving the vehicle V with the engine started, and a stop button 1e for stopping the vehicle by turning off the engine E.

Therefore, using the remote controller 1 makes it possible to move forward/backward the vehicle V to a desired position, using a transmission AT of a power train TM after starting the engine E.

On the other hand, the remote controller 1 is provided with NO-engine start button 1b, and the NO-engine start button 1b allows the narrow space slow moving operation apparatus for a vehicle according to the present invention to use independent power, not using the power of the engine E and the power train TM, without driving the engine E, which is another embodiment according to a part of various applications of the present invention and described below.

Further, the remote controller 1 can control the vehicle V using radio frequency as described above; however, may use an infrared signal for controlling at close positions around the vehicle V, which can improve safety, and to achieve this, an infrared sensor that receives an infrared signal from the remote controller 1 and transmits it to an ECU 2 is installed in the vehicle V.

Further, the narrow space slow moving operation apparatus for a vehicle according to the present invention uses the ECU 2 where a logic is programmed to process control signals of the remote controller 1, the ECU 2 is an ECU (Engine Control Unit) that is generally necessary for controlling a vehicle, and a TCU (Transmission Control Unit) may be used, if it is difficult to use the ECU.

The ECU 2 performs control preferentially on the bases of the following basic pre-conditions, when slow-moving of the vehicle V according to the present invention is performed at about 2 km/h. When the basic preconditions are not satisfied due to a driver's driving habits or other factors, the ECU 2 can limit the operations of several devices for the slow-moving in controlling the movement of the vehicle or alarm the driver to recognize the situation.

For example, the basic precondition is a low-velocity gear shift condition, and for this, the ECU 2 detects whether after parking the driver moves a shift lever SL to an LD (ex-Low Drive) which is an unmanned movement shift stage 11, i.e. a low-velocity gear for moving the vehicle V at a low velocity, and then, if it is not, it makes the driver recognize it.

Further, the basic precondition is a parking lever operation condition, and for this, the ECU 2 detects whether the driver locks a parking lever PL after parking, and if the driver locks the parking lever PL, it makes the driver recognize it.

Further, the basic precondition is a wheel alignment condition, for this, the ECU 2 detects whether the driver aligns the wheel in straight lines for straight movement after parking, and if the wheels were not aligned in straight lines, it makes the driver recognize it.

Further, the basic precondition is a road slope condition, for this, the ECU 2 detects how much the vehicle V is inclined after parking, and if the inclination exceeds an allowable inclination, it makes the driver recognize it, or it restricts the shift lever SL such that the shift lever cannot move to the LD (ex-Low Drive), the unmanned movement shift stage 11.

Sensor devices to detect position and situation for the basic preconditions are connected to the ECU 2 by using electronic circuits.

In addition, a logic, which continuously detects velocity and stops the vehicle V when the velocity exceeds a predetermined velocity so that the vehicle V moves at a low velocity in a narrow space, is implemented in the ECU 2, and for this, the ECU 2 receives signals from a common speed sensor 14.

Further, the narrow space slow-moving operation apparatus for a vehicle according to the present invention restricts driving the vehicle V even if a signal is transmitted from the remote controller 1 to the ECU 2 in order to first ensure safety. For example, it is when the slope of a road where the vehicle V is parked exceeds a predetermined limit, and for this, the narrow space slow-moving operation apparatus for a vehicle is provided with a slope detecting sensor 3, such as a gravity sensor.

Further, the narrow space slow-moving operation apparatus for a vehicle according to the present invention provides safety that it is possible to drive the engine E, with a brake pedal BP pressed down, when a signal is transmitted from the engine start button 1a to the ECU 2.

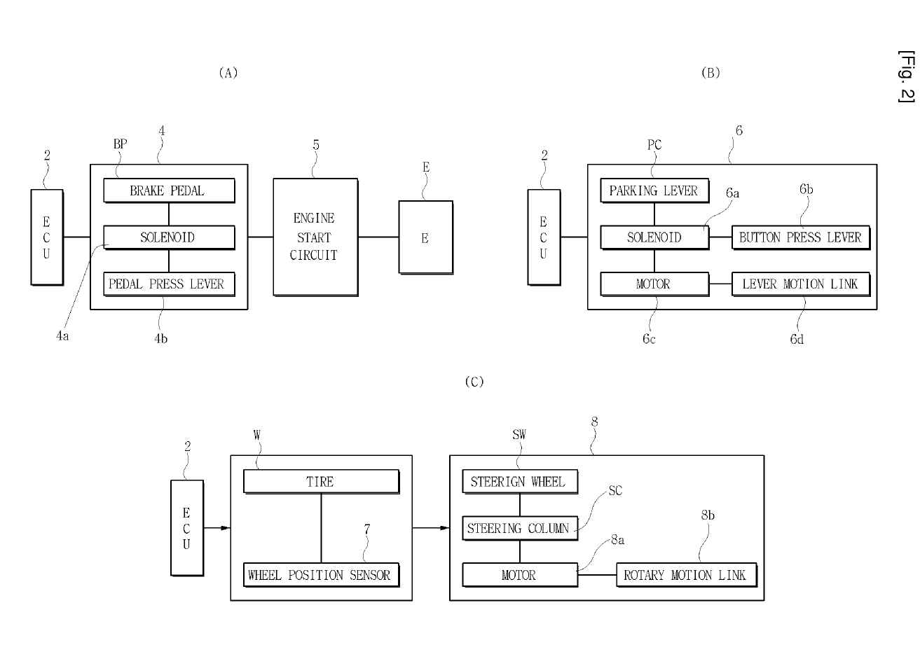

A brake operating unit 4 is provided to ensure safety in starting the engine E, and it is composed of, as shown in FIG. 2A, a solenoid 4a that generates power for automatically pressing down the brake pedal BP for braking in response to a signal from the ECU 2 and a press lever 4b that mechanically presses the brake pedal BP using the power of the solenoid 4a.

For example, as the press lever 4b, which is actuated by moving in or out a rod of the solenoid 4a, pulls the brake pedal BP of which one end is hinged, the brake pedal BP is pressed down about the hinge shaft.

When the brake pedal BP is pressed down as described above, the engine E starts, and the engine start is achieved by an engine start circuit 5 for a vehicle.

The brake operating unit 4 may not be provided in this embodiment, which is because it is not needed to operate the brake pedal BP when an accelerating pedal AP is released in a vehicle V that is moving at a low velocity of about 2 km/h or less.

Further, the narrow space slow-moving operation apparatus for vehicle according to the present invention is equipped with a wheel adjusting unit for moving the vehicle V straight after starting the engine, and the wheel adjusting unit reduces danger of contact of the vehicle V with objects around.

For this, the wheel adjusting unit, as shown in FIG. 2C, has a wheel sensor 7 that is attached to the front wheel of the vehicle V to detect state of the wheels not-aligned and a steering wheel operating part 8 that align the wheel by moving a steering wheel SW connected to a steering column SC.

The wheel sensor 7 generates a signal by detecting the amount of turning from the straight position of the wheel, and the steering wheel operating part 8 is composed of a motor 8a that generates power by control of the ECU 2 according to a signal of the wheel sensor 7 and a motion link 8b that mechanically rotates the steering wheel SW using the power of the motor 8a.

For example, the motion link 8b has a gear, which receives the rotational force of the motor 8a, at one end, and the other end of the motion link 8b is fixed to the steering wheel SW, or it may be configured in various ways according to the characteristics of the vehicle, such as using a decelerator that is engaged with a gear receiving the rotational force of the motor 8a, and directly rotates the steering column SC.

The wheel adjusting unit may not be provided in this embodiment, which is because when parking the vehicle V, the driver can always park the vehicle with the wheels always aligned straight.

Further, the narrow space slow-moving operation apparatus for a vehicle according to the present invention is provided with vehicle movement preparing units for moving the vehicle V at a low velocity after starting the engine, which includes an parking releasing unit 6 that operates the parking lever PL and a shift unit 9 that operates shift stage.

For this, the parking releasing unit 6, as shown in FIG. 2B, is composed of a solenoid 6a that generates power for automatically pulling the parking button to unlock the parking lever PL in response to a signal from the ECU 2 and a press lever 6b that mechanically pulls the button using the power of the solenoid 6a.

For example, as a rod of the solenoid 6a is moved in or out, the press lever 6b pulls the button such that a latch unit disposed inside is unlocked.

Further, the parking releasing unit 6 is composed of a motor 6c that generates power for moving up/down the parking lever PL and a motion link 6d that moves up/down the parking lever PL by the motor 6c.

For example, the motion link 6d has a gear, which receives the rotational force of the motor 6c, at one end, and the other end of the motion link 6d is fixed to the parking lever PL.

Further, the parking releasing unit 6 may further include a sensor and a buzzer that detects a position of the parking lever PL and generates an alarm, such that the ECU 2 allows the driver to recognize the situation, when a specific condition is satisfied, and take follow-up actions.

The parking releasing unit 6 may not be provided in this embodiment, which is because when the driver parks the vehicle V on level ground without a slope, the vehicle V does not unexpectedly move even if the driver does not lock the parking lever PL.

Meanwhile, in the parking releasing unit 6, an EPB (Electric Parking Brake) that is a motor power parking device, not using the parking lever PL, may be applied, in which, as the ECU 2 controls the motor for parking lock and unlock, configuration for controlling the parking lever PL is not needed.

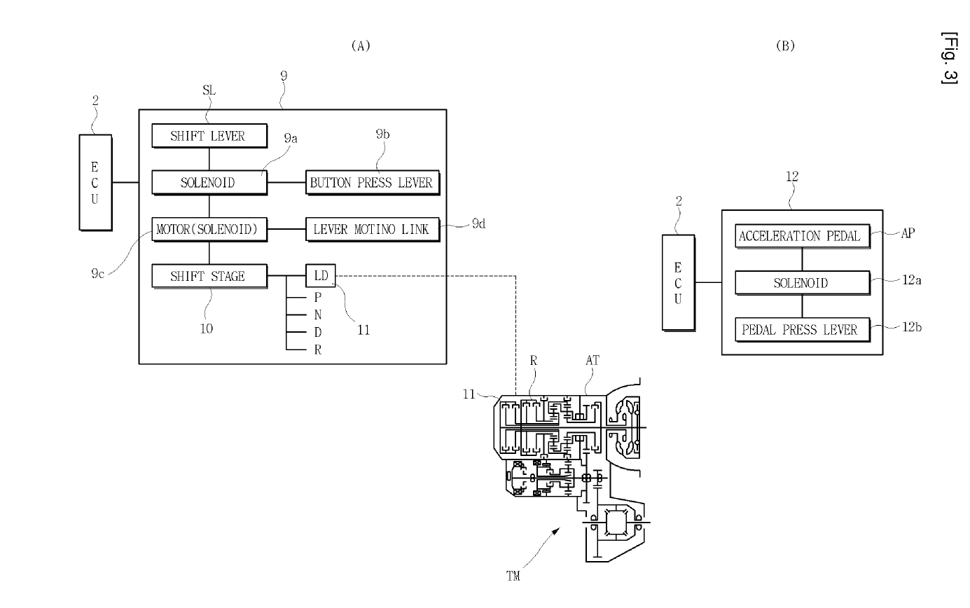

Further, the shift unit 9, as shown in FIG. 3A, is provided to move the shift lever SL to the LD (ex-Low Drive), which is the unmanned movement shift stage 11 for slow movement, from the parking position P, and for this, the shift unit 9 is composed of a solenoid 9a that generates power for automatically pulling a shift button to unlock the shift lever SL in response to a signal from the ECU 2 and a press lever 9b that mechanically pulls a button using the power of the solenoid 9a.

For example, as a rod of the solenoid 9a moves in or out, the press lever 9b pulls the button, such that the shift lever SL is unlocked.

Further, the shift unit 9 is composed of a motor 9c that generates power for moving the shift lever SL forward/backward and a motion link 9d that moves the shift lever SL forward/backward toward the unmanned movement shift stage 11, by the motor 9c.

For example, the motion link 9d has a gear, which receives the rotational force of the motor 6c, at one end, and the other end of the motion link 9d is fixed to the shift lever SL, or may be configured to move forward/backward the shift lever SL to the unmanned movement shift stage 11 while pulling or pushing the motion link 9d when the rod of the solenoid, which replaces the motor 9c, is moved in or out.

As described above, the LD (ex-Low Drive), which is the unmanned movement shift stage 11 where the shift lever SL is positioned to move the vehicle V at a low velocity, is a shift stage added to a shift stage 10 of P, N, D, R. The LD, which is the unmanned movement shift stage 11, is configured to connect an input shaft with an output shaft, like shift gears of P, N, D, R of a transmission AT. Further, the shift stage is made the same ways as P, N, D, R shifts in the transmission AT are achieved with gears and hydraulic circuits provided, such that design changes of the transmission AT for adding the LD, which is the unmanned movement shift stage 11, can be minimized.

Further, the LD, which is the unmanned movement shift stage 11, is configured to perform shifts for moving forward/backward by control of the ECU 2 that has received signals from the forward/backward buttons 1c, 1d of the remote controller 1.

Although the transmission AT is an automatic transmission herein, for a manual transmission, the LD, which is the unmanned movement shift stage 11, is constituted in the same way as P, N, D, R configured with the gears for achieving P, N, D, R shift and a shift pole in the transmission, similar to that for the automatic transmission.

Further, the LD, which is the unmanned movement shift stage 11, has gears for moving forward/backward and a shift structure, in which the forward gear is shifted by the control of the ECU 2 when a forward signal is generated by the remote controller 1 and the backward gear is shifted by the control of the ECU 2 when a backward signal is generated by the remote controller 1.

This can be implemented by a method using a reverse sun gear generally applied for backward shift of a transmission.

Further, the LD, which is the unmanned movement shift stage 11, induces an input/output gear ratio that prevents the velocity of the vehicle from increasing over a predetermined value, even if the acceleration pedal AP is pressed down at the largest, and the gear ratio is designed in consideration of the number of revolution of the engine.

Further, the LD, which is the unmanned movement shift stage 11, may be configured to have P-function for parking, in which as the shift lever SL moves to the LD, which is the unmanned movement shift stage 11, parking state, caused by P-positioning, is achieved. For example, similar to a common P-positioning, a select shaft is moved by a select cable by P-position selection and engaged with a manual plate roller rod parking pull parking gear groove.

In the LD, which is the unmanned movement shift stage 11, having the P-function, after the P-parking function is achieved and when a control signal of the remote controller 1 is transmitted to the ECU 2, the ECU 2 releases the P-function in the unmanned movement shift stage 11 and performs gear shift for the LD, which is the unmanned movement shift stage 11, by a control signal for the following forward or backward shift.

When the P-parking is activated and released, the select cable is generally operated for engagement/disengagement with/from the gear groove, and for this, a solenoid for operating the select cable is provided and controlled by the ECU 2.

As described above, by adding the P-function to the LD, which is the unmanned movement shift stage 11, as the shift lever SL moves to the LD, which is the unmanned movement shift stage 11, parking is automatically performed and another parking operation is not needed, such that the design of the shift lever assembly is not practically changed.

Further, the LD, which is the unmanned movement shift stage 11, may further include a sensor and a buzzer that detects whether the shift lever SL is positioned and generates an alarm, which allows the ECU 2 to perform the control in preferential consideration of the basic preconditions, such that the driver can recognize the situation and move restrictively the shift lever SL.

For example, when the ECU 2 performs the control in consideration of the basic pre-conditions, state of the wheel not-aligned is detected while the shift lever SL is positioned at the LD, which is the unmanned movement shift stage 11, and then the ECU 2 generates an alarm for the driver to recognize the situation.

Further, when the ECU 2 recognizes that the slope of the road exceeds a predetermined range, on the basis of the basic preconditions, and the driver wants to move the shift lever SL to the LD, which is the unmanned movement shift stage 11, the ECU 2 generates an alarm relating to movement of the shift lever SL or does not drive the solenoid or the motor to prevent movement of the shift lever SL, such that the driver can recognize the situation and take follow-up actions.

On the other hand, the LD, which is the unmanned movement shift stage 11 for moving a vehicle at a very low velocity, may not be provided, and a transmission that has been installed, that is, the low-velocity first stage of the transmission can be used instead of the LD. For this, the ECU 2 is provided with a logic that is programmed to control the amount of pressing of the acceleration pedal AP, with high precision.

The logic of the EUC 2 is variously implemented, and for example, a logic that subdivides in detail the movement of the solenoid and the lever moving to press the acceleration pedal AP through the solenoid and prevents the amount of pressing of the acceleration pedal AP from exceeding a predetermined value is used. That is, a logic that maintains the amount of pressing of the lever, which determines the amount of pressing of the acceleration pedal AP, at a low movement velocity of 2 km/h or less is used.

As described above, as the control of the amount of pressing of the acceleration pedal AP is minutely made within a narrow range through the ECU 2, it is easy to control the movement velocity of the vehicle V at 2 km/h or less, even if the low-velocity first stage of the transmission that has been installed is used.

Further, the narrow space slow-moving operation apparatus for vehicle according to the present invention has an acceleration unit 12 for moving the vehicle V at a low velocity after starting the engine, and the acceleration unit 12 is generally achieved by the acceleration pedal AP.

That is, the acceleration unit 12, as shown in FIG. 3B, is composed of a solenoid 12a that generates power for pressing the acceleration pedal AP in response to a signal of the ECU 2 and a press lever 12b that presses the acceleration pedal AP using the power of the solenoid 12a.

For example, as the press lever 12b, which is actuated when a rod of the solenoid 12a is moved in and out, pulls the acceleration pedal AP of which one end is hinged, the acceleration pedal AP is pressed about the hinge shaft.

Further, the narrow space slow-moving operation apparatus for a vehicle is further provided with a means for safety in moving forward/backward, which is an object detecting sensor 13 that detects objects around the space where the vehicle V moves.

The object detecting sensor 13 is attached to the front or rear sides and various types of sensors are used, and for example, an ultrasonic sensor, an infrared sensor, or a contact sensor is used.

Meanwhile, the narrow space slow-moving operation apparatus for a vehicle makes it possible to move the vehicle V without using the engine E, i.e. with the engine E stopped, and for this, an independent power assembly 20 that generates power by control of the ECU 2 is further provided.

The independent power assembly 20 may be used as an assistant means for the way of using the engine E, or can be configured to achieve the narrow space slow-moving operation by itself.

For this, the independent power assembly 20, as shown in FIG. 1, includes an actuator 21 that generates power by control of the ECU 2 that has received a signal from the remote controller 1, a decelerator 23 that increases torque generated by the actuator 21, and a rotary gear 24 that generates rotational force by the decelerator 23 to rotate an impelling shaft P.

The actuator 21 is variously configured and generally composed of a motor that generates rotational force and an inverter.

The actuator 21 is driven by a battery that is individually provided, or electric power generated by the engine.

Using power generated by the engine implies a common technology in which the actuator 21 is connected in an electric circuit to a battery for a vehicle, where power is charged by driving of the engine, the actuator 21 is driven by power of the battery for a vehicle while the rotational force of the engine is not transmitted to the power train when the engine is driven, and the engine just charges the battery for a vehicle.

Further, the decelerator 23 has a gear arrangement and a gear ratio that generate large output torque to rotate the rear wheel through a differential gear by rotating the impelling shaft P at a low velocity, and the gear ratio is designed according to moving velocity (the maximum 2 km/h or less) of the vehicle V.

Further, a clutch 22 is further provided between the actuator 21 and the decelerator 23. The clutch 22 connects the actuator 21 with the decelerator 23 only when the actuator 21 is driven, such that the rotational force of the impelling shaft P is not distributed to the actuator 21 in normal driving.

The independent power assembly 20 does not need configuration for operating the acceleration pedal AP and the brake pedal BP; therefore, the ECU 2 can be simply achieved without a control logic for the engine start, brake pedal BP, and acceleration pedal AP, in the control logic.

However, the brake operating unit 4 that operates the brake pedal BP may still be provided when the independent power assembly 20 is used. That is, when the vehicle V moved by the independent power assembly 20 exceeds 2 km/h, it can be configured to operate the brake pedal BP to quickly stop the vehicle; however, it is practically not applied because the vehicle moves at a very low velocity on a flat road.

Further, the independent power assembly 20 may be configured to drive the front wheels, which can be achieved when the actuator rotates the input shaft portion of the differential gear for the front wheels.

According to the narrow space slow-moving operation apparatus for vehicle, when the space where a driver's vehicle V is parked or unparked is so narrow K that the doors cannot be sufficiently opened due to first and second vehicles A, B around, all of the driver and passengers get out of the vehicle and then the driver moves the vehicle V using the remote controller 1. In particular, big body size people who need a wide space to get in/out of the vehicle, as compared with normal body size people, and people sitting in wheelchairs can be free from the inconvenience which they feel when getting in/out of vehicles.

The ECU 2 that drives the vehicle at about 2 km/h or less according to the present invention executes the following logic such that the conditions of the vehicle V, which is being parked or has been parked, agree with the basic preconditions.

That is, after the vehicle V is parked, it is informed to the driver whether the shift lever SL is positioned to the LD (ex-Low Drive), which is the unmanned movement shift stage 11, whether the parking lever PL is locked, whether the wheels are aligned, or whether the slope of the road where the vehicle is parked satisfies the allowable value, such that the driver can park the vehicle V while always recognizing the basic preconditions.

Therefore, the control of a vehicle equipped with the narrow space slow-moving operation apparatus for a vehicle is explained using an example of moving his/her vehicle, which is parked, forward/backward to unpark the vehicle V, with the basic preconditions considered.

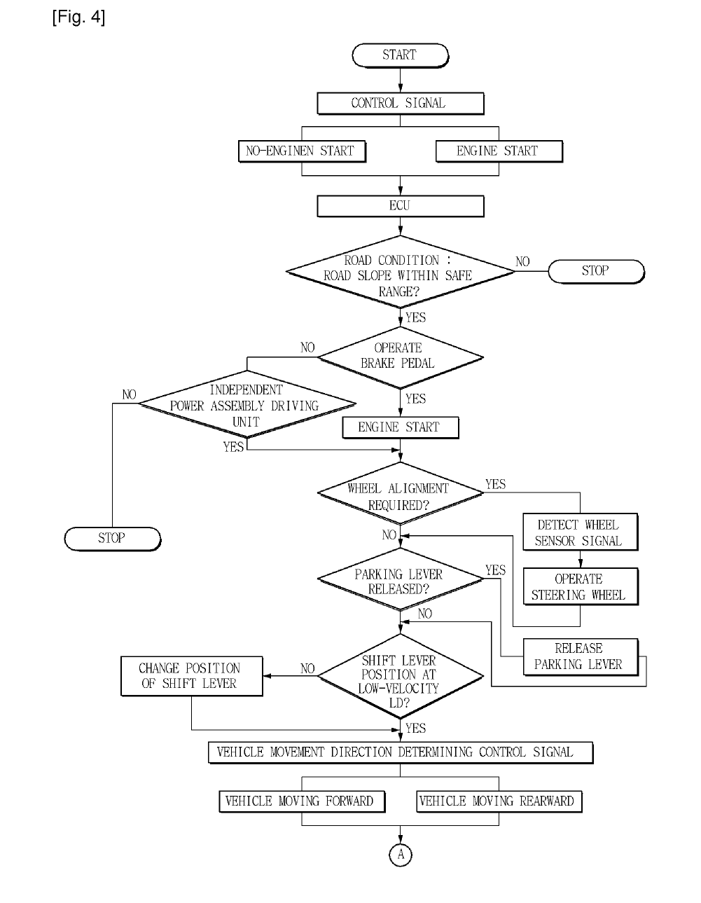

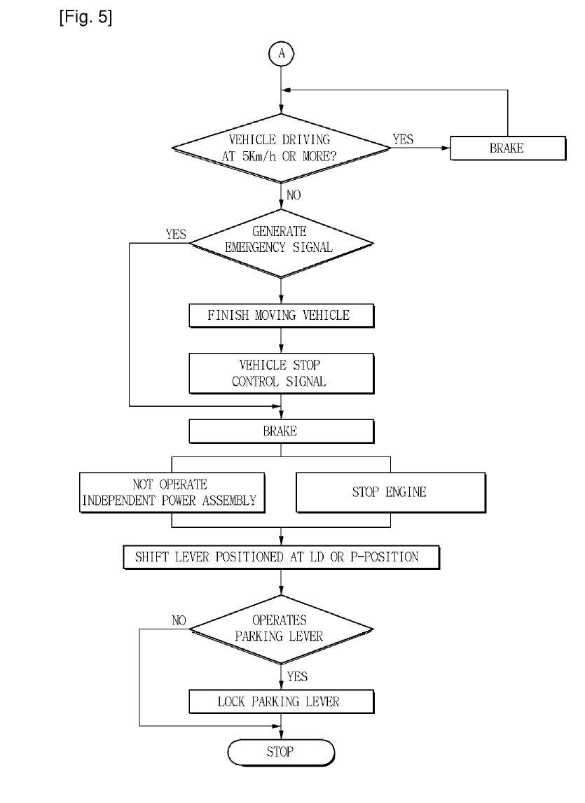

That is, as shown in FIGS. 4 and 5, when the ECU 2 receives a radio signal generated by the engine start button 1a or the NO-engine start button 1b of the remote controller 1, the ECU 2 checks the amount of slope of the road where the vehicle V is parked, before starting the engine E.

The ECU 2 continuously monitors signals that are transmitted from the slope detecting sensor 3, and when a signal value of the slope detecting sensor 3 exceeds a predetermined value, the ECU 2 does not start the engine and does not proceed to all of the following operations, even if a signal is inputted from the remote controller 1.

The ECU 2 can let the driver know that the road slope exceeds the predetermined region by generating an alarm, or restricting the shift lever SL such that it cannot move to the LD, which is the unmanned movement shift stage 11.

When determining that the road slope is within the predetermined value and the vehicle V parked can move, the ECU 2 performs the operation for starting the engine E, that is, the ECU 2 operates the brake operating unit 4 such that the brake pedal BP is pressed down.

This is achieved by the following operation. As the ECU 2 drives the solenoid 4a, the rod of the solenoid 4a moves in (or out) and the pressing lever 4b is correspondingly operated, such that the press lever 4b pulls the brake pedal BP with one end hinged.

As described above, as the brake pedal BP is pressed down, the ECU 2 starts the engine E using the engine start circuit 5 for a vehicle, in which it is checked that the brake pedal BP is pressed down, by a common contact or pressure sensor.

When the engine is started as described above, if the brake pedal BP is not pressed down, the ECU 2 determines that it is a control using the independent power assembly 20, and performs the next operation.

Continuously, as the engine E starts, the ECU 2 releases the brake pedal BP pressed down, by turning off the solenoid 4a, and detects the wheel alignment to reinforce again the safety for movement.

The wheel alignment is directly detected without starting the engine E when the vehicle V is moved by the independent power assembly 20, not the power of the engine E, which will be described below.

The operation for aligning wheels is performed as follows. The ECU 2 controls the wheel adjusting unit, that is, the ECU 2 determines whether the amount of turning of the front wheels exceeds a predetermined value while continuously detecting signals transmitted from the wheel sensor 7, and then if exceeded, the wheels are aligned by the steering wheel SW, which is operated by the steering wheel operating part 8.

As the ECU 2 detecting a signal of the wheel sensor 7 drives the motor 8a, the motion link 8b that is operated by the motor 8a rotates the steering wheel SW until the front wheels are aligned, such that the operation of the steering wheel SW is finished.

The wheel alignment may not be practically implemented, which is because as the driver parks the vehicle in a straight line, the vehicle can move straight without performing the wheel arrangement operation for the wheels that have been aligned.

When it is checked that the wheels are aligned after the engine E starts, the ECU 2 releases the parking lever PL and moves the shift lever SL for LD shift, which is the movement shift stage 11 for movement of the vehicle V, and for this, the ECU 2 uses the parking releasing unit 6 that operates the parking lever PL and the shift unit 9 that operates the shift stage.

That is, in order to release the parking lever PL, the ECU 2 drives the solenoid 6a such that the press lever 6b pulls the parking button of the parking lever PL to be unlocked, and then drives again the motor 6c such that the motion link 6d moves down the parking lever PL to be unlocked.

In this control, the ECU 2 checks whether the shift lever SL is positioned at the LD, which is the unmanned movement shift stage 11, and then operates the parking lever PL. For example, in the configuration of the LD, which is the unmanned movement shift stage 11, including the parking function, when the driver positions the shift lever SL to the LD, which is the unmanned movement shift stage 11, and then tries to lock the parking lever PL while getting out of the vehicle, the ECU 2 generates an alarm such that the driver gets out of the vehicle without locking the parking lever PL, in which the ECU 2 does not execute the operation logic for the parking lever PL.

Next, the ECU 2 unlocks the shift lever SL by operating the shift unit 9, and then prepares for moving forward/backward by moving the shift lever SL from the parking position P to the LD, which is the unmanned movement shift stage 11.

That is, the ECU 2 drives the solenoid 9a such that the press lever 9b unlocks the shift lever SL by pulling the button, and then drives again the motor 9c, such that the motion link 9d moves the shift lever SL to the LD, which is the unmanned movement shift stage 11.

The ECU 2, which performs the above control, informs a specific situation to the driver, for example, generates an alarm to make the driver recognize the present situation, which is operated to prevent that the vehicle V cannot moves straight when the shift lever SL is positioned to the LD, which is the unmanned movement shift stage 11, and the wheels of the vehicle are not aligned.

Further, the ECU 2 can restrict the shift lever SL so as not to be moved to the LD, which is the unmanned movement shift stage 11, which prevents the driver from moving the shift lever SL to keep the movement velocity from exceeding the predetermined range when the vehicle moves on a road of which the slope exceeds the predetermined range, and which can be replaced by making an alarm such that the driver does not move the shift lever.

The movement of the shift lever SL to the LD, which is the unmanned movement shift stage 11, can be achieved by operating the shift stage of the transmission AT, that is, in the same way as the shift gear is operated according to P, N, D, R of the shift stage 10, the LD stage shift gear provided in the transmission AT connects the input shaft with the output shaft, such that the vehicle V makes preparation for movement at a low velocity of about 2 km/h or less.

The ECU 2 that makes the operation for the LD, which is the unmanned movement shift stage 11, in the above operation, releases the parking-operation, which has been made, by controlling the solenoid, and then operates the gear shift for forward-shift or backward-shift in response to the next control signal.

This operation is applied or not according to the situations, because, in the configuration in which the LD, which is the unmanned movement shift stage 11, is provided with P-function for parking, when the driver moves the shift lever SL to the LD, which is the unmanned movement shift stage 11, and gets out of the vehicle, parking function is achieved and the operation state to the LD, which is the unmanned movement shift stage 11, is prepared, in which the ECU 2 does not execute the logic for the shift unit 9 and proceeds to the next step.

In addition, when the driver moves the shift lever SL to the LD, which is the unmanned movement shift stage 11, getting out of the vehicle, it does not need to unlock the parking lever PL.

As described above, in executing the logic in the ECU 2 according to the condition of the vehicle V that is in stop in this embodiment, when the condition of the vehicle V is set, the corresponding logic is not executed and the next step can proceed.

The flexibility in executing the logic of the ECU 2 makes the logic of the ECU 2 simple and various devices are not needed, when the driver can keep the vehicle V in a specific condition, such that it is possible to achieve various configurations.

On the other hand, when the low-velocity first stage of a transmission according to the related art, which is another embodiment of the present invention, is used, it is not required to move the shift lever SL, in which since the LD, which is the unmanned movement shift stage 11, includes the parking function, when the ECU 2 performs slow movement, the LD, which is the unmanned movement shift stage 11, releases the parking function and then shifts the low-velocity first stage 1 of the transmission, such that it is not required to move the shift lever SL.

Therefore, the ECU 2 minutely controls the amount of pressing the acceleration pedal AP such that the velocity of the vehicle that is moving does not exceed 2 km/h.

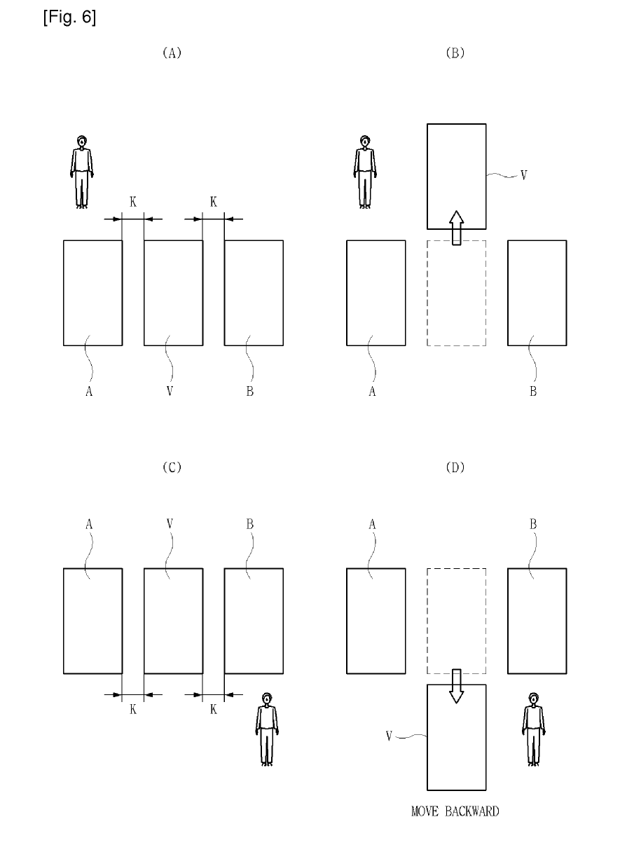

Thereafter, when the forward or backward button 1c, 1d of the remote controller 1 is pressed, the ECU operates the acceleration pedal AP to move the vehicle. That is, when the forward button 1c is pressed, the vehicle moves forward as shown in FIG. 6A, and when the backward button 1d is pressed, the vehicle moves backward as shown in FIG. 6C, such that the driver can drive out the vehicle V parked in the narrow space K between the first and second vehicles A, B.

The ECU 2 presses down the acceleration pedal AP for movement of the vehicle V according to the operation of the buttons of the remote controller 1, in which, after the solenoid 12a of the acceleration unit 12 is driven by the ECU 2, the solenoid 12a operates the press lever 12b to reduce the amount of pressing the acceleration pedal AP, or releases the acceleration pedal AP and presses down the brake pedal BP, such that the vehicle can move at the maximum speed of 2 km/h or less.

While the vehicle V moves as described above, the ECU 2 continuously monitors signals of a speed sensor 14 such that the maximum speed does not exceeds 2 km/h, and when it exceeds the maximum speed of 2 km/h, the ECU 2 decreases the velocity by adjusting the amount of pressing the acceleration pedal AP.

When the low-velocity first stage of the transmission according to another embodiment of the present invention is used, the ECU 2 executes an acceleration pedal control logic, which is specifically configured, to minutely control the amount of pressing as compared with another embodiment, when controlling the acceleration pedal AP on the basis of signals of the speed sensor 14.

Further, the ECU 2 ensures safety in forward/backward movement by preventing the vehicle V from contacting with objects around the movement space, which is achieved by the ECU 2 continuously monitoring signals of an object detecting sensor 13.

When it is difficult to ensure safety, the ECU 2 stops the vehicle V, ignoring the steps that has proceeded, and stop the slow-moving mode.

By this operation, as shown in FIG. 6B or FIG. 6D, the vehicle V completely moves out of the narrow space K between the first and second vehicles A, B, and then the driver presses the stop button le of the remote controller 1 such that the ECU 2 executes a step for stopping the engine E.

Stopping the engine E is generally a condition, such as parking or stop of the vehicle, and for this, the ECU 2 that has received the signal of the stop button 1e of the remote controller 1 stops the vehicle V by pressing down the brake pedal BP, stops the engine E using the engine start circuit 5, and then locks the parking lever PL or moves the shift lever SL to the P-position, if necessary.

It may not be required to move the shift lever SL for parking, which is because the LD, which is the unmanned movement shift stage 11, includes the parking function.

When the vehicle V is driven completely out into a wide space around, big body size people who need a wide space to get in/out of the vehicle, as compared with normal body size people, and people sitting in wheelchairs can get in/out of the vehicle without inconvenience, and they can normally drive the vehicle using the engine start key.

Meanwhile, the present invention can move the vehicle V using a specific actuator without starting the engine E, which is achieved by the ECU 2 recognizing a radio signal generated by the NO-engine start button 1b of the remote controller 1.

That is, the ECU 2 receiving the signal of the NO-engine start button 1b of the remote controller 1 checks the amount of slope of the road using the slope detecting sensor 3 and ensures safety for moving the vehicle V, and then align the wheels using the wheel sensor 7 and the steering wheel operating part 8.

In this operation, the brake pedal BP is not operated, because the condition of the road where the vehicle V is parked is sufficiently safe.

Next, the ECU 2 that has checked the wheel alignment releases the parking lever PL and moves the shift lever SL to the LD shift position, for the LD shift of the movement shift stage 11, such that the vehicle V makes preparation for moving.

In this preparation state, a signal is transmitted to the ECU 2 by pressing the forward and backward button 1c, 1d of the remote controller 1, the ECU 2 drives the actuator 21, and the decelerator 23 connected with a clutch 22 correspondingly generates output torque. The output torque of the decelerator 23 rotates the rotary gear 24 engaged with the decelerator 23 and fixed to the impelling shaft P, such that the impelling shaft P rotates and the rear wheels are driven through the differential gear, and as a result, the vehicle V is moved.

The vehicle V is moved forward as shown in FIG. 6A, without operation of the acceleration pedal AP, when the forward button 1c of the remote controller 1 is operated, and when the backward button 1d is operated the vehicle is moved backward as shown in FIG. 6C, such that it is possible to drive out the driver's own vehicle V placed in the narrow space K between the first and second vehicles A, B.

In this operation, in addition to continuously monitoring signals of the speed sensor 14 such that the maximum speed of the vehicle V does not exceed 2 km/h, the ECU 2 continuously monitors signals of the object detecting sensor 13 to ensure the safety for moving forward/backward by preventing contact with objects around the movement space.

As shown in FIG. 6B or FIG. 6D, thereafter, the vehicle V is completely moved out of the narrow space K between the first and second vehicles A, B, and then the ECU 2 receiving the signal of the stop button 1e of the remote controller 1 stops the vehicle V by stopping the actuator 21, and then executes necessary control processes.

That is, the ECU 2, if necessary, locks the parking lever PL, or moves the shift lever SL to the P-position, or stops the vehicle V by pressing down the brake pedal BP.

In this situation, big body size people who need a wide space to get in/out of the vehicle, as compared with normal body size people, and people sitting in wheelchairs can get in the vehicle without inconvenience, and then normally drive the vehicle.

1. A narrow space slow moving operation apparatus for vehicle, comprising:
a remote controller 1 that transmits various control signals to a vehicle V, which all of passengers, including a driver, get out of or in which nobody is, when the vehicle is parked or needs to be parked at a narrow space between vehicles;
an unmanned slow movement shift stage LD 11 that is added to a shift stage 10 of a transmission to allow an ECU 2 to control the vehicle V in a slow movement control mode when signals from the remote controller is received;
the ECU 2 that controls the vehicle V in response to each signal transmitted from the remote controller 1, with a shift lever SL positioned at the unmanned slow movement shift stage LD 11; and
a slow-moving part that moves the vehicle V at a low velocity by transmitting power to wheels in response to a control signal generated by the ECU 2.

2. The narrow space slow moving operation apparatus for vehicle according to claim 1, wherein the unmanned slow movement shift stage LD 11 induces the parking state when the shift lever SL is positioned at the unmanned slow movement shift stage LD, and the slow-moving part releases the parking state in response to a control signal generated by the ECU 2.

3. The narrow space slow moving operation apparatus for vehicle according to claim 1, wherein the slow-moving part drives an engine E in response to a control signal generated by the ECU 2 and transmits power to the wheels.

4. The narrow space slow moving operation apparatus for vehicle according to claim 1, wherein the slow-moving part includes an independent power assembly 20 that is driven by a control signal generated by the ECU 2 and transmits power to the wheels.

5. The narrow space slow moving operation apparatus for vehicle according to claim 4, the independent power assembly 20 is driven by electric power of a battery specifically provided, or electric power generated by the engine E.

6. The narrow space slow-moving operation apparatus for vehicle according to claim 4, wherein the independent power assembly 20 rotates an impelling shaft P that transmits rotation power to rear wheels.

7. The narrow space slow moving operation apparatus for vehicle according to claim 3 or 4, wherein the slow-moving part moves the vehicle at a low velocity by controlling a brake pedal BP or/and an acceleration pedal AP.

8. The narrow space slow moving operation apparatus for vehicle according to claim 1, wherein the slow-moving part uses a low-velocity first stage of a transmission as the unmanned slow movement shift stage LD 11, and for this, the ECU 2 is provided with a logic that adjusts the amount of pressing the acceleration pedal AP or the brake pedal BP to keep a slow-moving velocity, in order to minutely adjust the amount of pressing the acceleration pedal AP.

9. The narrow space slow moving operation apparatus for vehicle according to any one of claim 3, 4 or 8, wherein the slow-moving part release a parking lever PL when the parking lever PL is set, or generates an alarm when the shift lever SL is positioned at the unmanned slow movement shift stage LD 11 and, at the same time, the parking lever PL is set.

10. The narrow space slow moving operation apparatus for vehicle according to any one of claim 3, 4 or 8, wherein the slow-moving part moves the shift lever SL to the unmanned slow movement shift stage LD 11, when the shift lever SL is not positioned at the unmanned slow movement shift stage LD 11.

11. The narrow space slow moving operation apparatus for vehicle according to any one of claim 3, 4 or 8, wherein the slow-moving part detects state of the wheels not-aligned and aligns the wheels or generates an alarm when the shift lever SL is positioned at the unmanned slow movement shift stage LD 11.

12. The narrow space slow moving operation apparatus for vehicle according to any one of claim 3, 4 or 8, wherein the slow-moving part further includes a slope detecting sensor 3 that detects the slope condition of a road where the vehicle is stopped, and wherein the ECU 2 operates in response to a control signal of the remote controller 1 only within a predetermined slope condition range, or generates an alarm or restricts the shift lever SL if the predetermined slope condition range is exceeded, when the shift lever SL is moved to the unmanned slow movement shift stage LD 11.

13. The narrow space slow moving operation apparatus for vehicle according to claim 1, wherein the ECU 2 further includes a safety checking part that prevents the vehicle V, which is moving, from exceeding a predetermined velocity and contacting with objects around, and
wherein the ECU 2 stops the vehicle V, ignoring the slow movement mode of the vehicle V, when receiving a signal of the safety checking part.

14. The narrow space slow moving operation apparatus for vehicle according to claim 1, wherein the slow-moving part includes:
an engine start circuit 5 that generates an engine start signal of the ECU 2 for a vehicle;
a brake operating unit 4 that has a solenoid 4a and a press lever 4b for pressing and releasing the brake pedal BP by control of the ECU 2;
a wheel aligning unit that has a wheel sensor 7 transmitting a signal about state of the wheels not-aligned to the ECU 2 and a motion link 8b rotating a steering wheel SW by a motor 8a generating power by the ECU 2 such that the wheels of the vehicle is aligned in straight lines;
an parking releasing unit 6 that has a solenoid 6a and a press lever 6b pulling a parking button to unlock the parking lever PL by control of the ECU 2 and a motion link 6d moving up/down the parking lever PL using power generated by a motor 6c;
a shift unit 9 that has a solenoid 9a and a press lever 6b automatically pulling a shift button such that the shift lever SL is unlocked to move the shift lever SL to the unmanned movement shift stage LD 11 for slow movement, and a motion link 9d moving forward/backward the shift lever SL using power generated by a motor 9c; and
an acceleration unit 12 that has a solenoid 12a and a press lever 12b for pressing or releasing the acceleration pedal AP by control of the ECU 2.

15. The narrow space slow moving operation apparatus for vehicle according to claim 4, wherein the independent power assembly 20 includes an actuator 21 generating power by control of the ECU 2 receiving a signal of the remote controller 1, a decelerator 23 increasing torque generated by the actuator 21, and a rotary gear 24 generating rotational force by the decelerator 23 to rotate the impelling shaft P.

16. A narrow space slow moving operation method for vehicle, comprising:
a step of checking a slow movement mode in which an ECU 2 recognizing a slow movement order signal from a remote controller 1 checks that a shift lever SL is positioned at an unmanned slow movement shift stage LD 11, or moves the shift lever to the unmanned slow movement shift stage LD 11;
a step of starting engine in which after the position of the shift lever SL at the unmanned slow movement shift stage LD 11 is checked, the ECU presses down a brake pedal and then starts an engine;
a step of setting slow movement shift in which after the engine starts, the ECU shifts the gear from a parking state to slow movement, in response to signals of forward and backward buttons 1c, 1d of the remote controller 1;
a step of moving in which after the gear is shifted, an acceleration AP is pressed to move a vehicle V, or the brake pedal BP is released; and
a step of completing movement in which when a signal of a stop button 1e of the remote controller 1 is received or a predetermined distance passes, the ECU 2 stops the vehicle V by pressing down the brake pedal BP to stop the vehicle V, shifts the gear to the parking state, and stops the engine E.

17. A narrow space slow moving operation method for vehicle, comprising:
a step of checking a slow movement mode in which an ECU 2 recognizing a slow movement order signal from a remote controller 1 checks that a shift lever SL is positioned at an unmanned slow movement shift stage LD 11, or moves the shift lever to the unmanned slow movement shift stage LD 11;
a step of preparing for slow movement in which after the position of the shift lever SL at the unmanned slow movement shift stage LD 11 is checked, the ECU releases parking state;
a step of independent-power movement in which after the parking state is released, the ECU 2 operates an independent power assembly 20 to generate output torque through an actuator and a decelerator 23 and rotate a rotary gear 24 fixed to an impelling shaft P using the output torque generated by the decelerator 23 such that the impelling shaft P rotates and the rear wheels are driven through a differential gear, and as a result a vehicle V is moved; and
a step of finishing movement in which when a signal of a stop button 1e of the remote controller 1 is received or a predetermined distance passes, the ECU stops the operation of the independent power assembly 20 and induces parking state.

18. The narrow space slow moving operation method for vehicle according to claim 16 or 17, further comprising a step of safe movement in which, while the vehicle V moves, the ECU 2 controls the movement velocity, continuously checks whether to contact with objects around, and halts the vehicle V when an abnormal situation appears, such as excess in velocity or contact with an object.

19. The narrow space slow moving operation method for vehicle according to claim 16 or 17, further comprising a step of checking safety in which when a signal is received from the remote controller 1, the ECU 2 detects the slope condition of a road where the vehicle V is stopped, and controls the vehicle V only within a predetermined slope condition range, or when the shift lever SL is moved to the unmanned slow movement shift stage LD 11, generates an alarm or restricts the shift lever, if the predetermined slope condition range is exceeded.
